(19) United States
(12) Patent Application Publication
(10) Pub. No.: US 2025/0197105 A1
(43) Pub. Date: Jun. 19, 2025

(54) STEP-ON AND HAND-PRESSED TRASH CAN

(71) Applicant: Jiangmen Jinlong High Technology Industrial Co., Ltd., Guangdong (CN)

(72) Inventors: Jinsheng LIAO, Guangdong (CN); Huanjiu LU, Guangdong (CN)

(21) Appl. No.: 18/432,454

(22) Filed: Feb. 5, 2024

(30) Foreign Application Priority Data
Dec. 13, 2023 (CN) 202311718226.0

(51) Int. Cl. B65F 1/16

(52) U.S. Cl. CPC B65F 1/163

(57) ABSTRACT

A step-on and hand-pressed trash can, including: a main body, including a lid and a can body; a swing arm mechanism having one end articulated with the lid and the other end articulated with the can body; and a transmission mechanism, including a push rod and an ejector, one end of the push rod being articulated with the swing arm mechanism, and the push rod being provided with a supporting part abutting against a movable end of the ejector.

### CROSS-REFERENCE TO RELATED APPLICATION

This application is based on and claims the benefit of priority from Chinese Patent Application No. 2023117182260, filed on 13 Dec. 2023, the entirety of which is incorporated by reference herein.

### TECHNICAL FIELD

The present disclosure relates to the technical field of cash cans, and in particular to a step-on and hand-pressed trash can.

### BACKGROUND

The lid of the conventional trash can is mainly opened in a step-on manner. If the step-on drive structure fails to open the lid, the lid needs to be opened manually. However, for the sake of aesthetics, the lid of the conventional trash can is usually closed on the inner side of the opening of the trash can, which is inconvenient and troublesome to open manually.

### SUMMARY

In order to solve at least one of the technical problems in the existing technology, the present disclosure provides a step-on and hand-pressed trash can, a lid of which can be conveniently opened in a step-on or hand pressing manner and is very practical.

In a first aspect of the present disclosure, an embodiment provides a step-on and hand-pressed trash can, including: a main body, including a lid and a can body; a swing arm mechanism having one end articulated with the lid, and the other end articulated with the can body; and a transmission mechanism, including a push rod and an ejector, where one end of the push rod is articulated with the swing arm mechanism, and the push rod is provided with a supporting part abutting against a movable end of the ejector.

According to embodiments of the present disclosure, the step-on and hand-pressed trash can at least has the following beneficial effects. By connecting the push rod with a foot pedal, the lid can be opened by stepping on the foot pedal to drive the swing arm mechanism to move; or by pressing the lid, the supporting part presses the ejector under the drive of the swing arm mechanism and the push rod, and the ejector then lifts the supporting part to open the lid. When the lid is closed, the supporting part presses the ejector, and the ejector is restored to close the lid. Therefore, the lid can be conveniently opened not only by stepping but also by pressing, leading to increased practicability and convenience.

According to some embodiments of the present disclosure, the swing arm mechanism includes a first swing arm, a second swing arm, and a third swing arm. The second swing arm has a greater length than the third swing arm in a horizontal direction. The first swing arm is provided with a first end and a second end. One end of the second swing arm is articulated with the can body, and the other end of the second swing arm is articulated with the first end. One end of the third swing arm is articulated with the can body, and the other end of the third swing arm is articulated with the second end. The push rod is articulated with the second swing arm.

According to some embodiments of the present disclosure, the can body is provided with a first connector, and the second swing arm and the third swing arm are articulated with the can body through the first connector.

According to some embodiments of the present disclosure, the lid is provided with a second connector connected to the first swing arm, and a side of the second connector facing the first swing arm is provided with a notch matching the first swing arm.

According to some embodiments of the present disclosure, the can body is provided with a buffer, and the push rod is provided with a first contact plate abutting against a movable end of the buffer.

According to some embodiments of the present disclosure, the buffer and the ejector are arranged at two sides of the push rod, respectively.

According to some embodiments of the present disclosure, the push rod includes a first plate and a plurality of second plates. The first plate is arranged in a vertical direction. The plurality of second plates are all arranged on the first plate at intervals. A reinforcing rib is arranged between two adjacent second plates. The first plate is articulated with the swing arm mechanism.

According to some embodiments of the present disclosure, the can body is provided with a first partition and at least two second partitions. The first partition is arranged in the vertical direction, and the at least two second partitions are arranged on the first partition at intervals and are arranged at two sides of the push rod, respectively.

Additional aspects and advantages of the present disclosure will be partially set forth in the following description, and will partially become apparent from the following description or be understood through practice of the present disclosure.

### BRIEF DESCRIPTION OF DRAWINGS

The above and/or additional aspects and advantages of the present disclosure will become apparent and easily understood from the description of embodiments in conjunction with the following accompanying drawings, in which:

FIG. 1 is a sectional view of a step-on and hand-pressed trash can according to an embodiment of the present disclosure;

FIG. 2 is a partially enlarged schematic diagram at A in FIG. 1; and

FIG. 3 is a schematic diagram of a buffer and an ejector in the step-on and hand-pressed trash can according to an embodiment of the present disclosure.

### REFERENCE NUMERALS

lid 110; second connector 111; can body 120; first connector 121; first partition 122; second partition 123;
push rod 210; first plate 211; second plate 212; reinforcing rib 213; supporting part 214; first swing arm 221; second swing arm 222; third swing arm 223; first end 224; second end 225;
ejector 310; buffer 320.

### DETAILED DESCRIPTION

The embodiments of the present disclosure are described in detail below, and the examples of the embodiments are shown in the accompanying drawings, throughout which like reference numerals represent like elements or elements having the same or similar functions. The embodiments described below with reference to the accompanying drawings are exemplary and are merely intended to illustrate the present disclosure and are not to be construed as limiting the present disclosure.

In the description of the present disclosure, it should be understood that orientation descriptions involved, e.g., orientations or positional relationships indicated by terms such as “upper”, “lower”, “front”, “rear” and the like, are based on the orientations or positional relationships shown in the accompanying drawings. These relative terms are for convenience of description and do not require that the present disclosure be constructed or operated in a particular orientation, and therefore cannot be construed to limit the present disclosure.

In the description of the present disclosure, “several” means one or more, while “a plurality of” means two or more. “Greater than”, “less than”, “exceed” and the like should be understood as excluding the following number, while “more than”, “less than”, “within” and the like should be understood as including the following number. If described, “first”, “second” and the like are merely used to distinguish technical features and are not intended to indicate or imply relative importance or to implicitly indicate the number of indicated technical features or to implicitly indicate a precedence relationship of the indicated technical features.

In the description of the present disclosure, unless explicitly defined otherwise, the words such as “arrange”, “mount” and “connect” should be understood in a broad sense, and those having ordinary skills in the art can reasonably determine the specific meanings of the terms in the present disclosure in conjunction with the specific contents of the technical scheme.

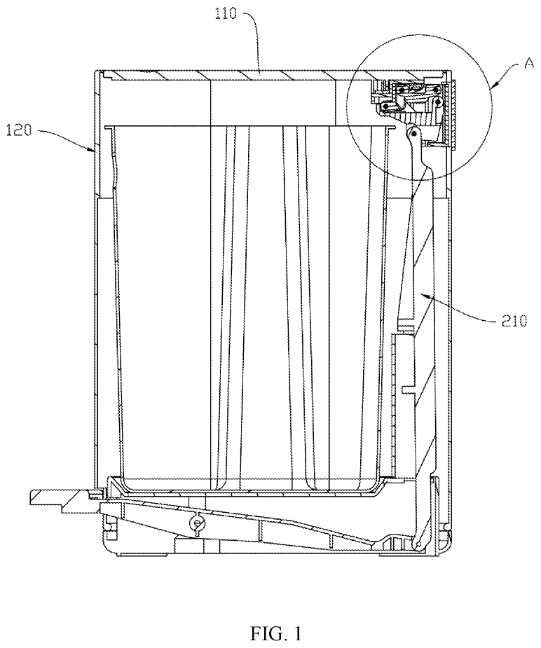

Referring to FIG. 1 to FIG. 3, a step-on and hand-pressed trash can according to an embodiment in a first aspect of the present disclosure includes: a main body, including a lid 110 and a can body 120; a swing arm mechanism, having one end articulated with the lid 110 and the other end articulated with the can body 120; and a transmission mechanism, including a push rod 210 and an ejector 310. One end of the push rod 210 is articulated with the swing arm mechanism, and the push rod 210 is provided with a supporting part 214, which abuts against a movable end of the ejector 310.

By connecting the push rod 210 with a foot pedal, the lid 110 can be opened by stepping on the foot pedal to drive the swing arm mechanism to move; or by pressing the lid 110, the supporting part 214 presses the ejector 310 under the transmission of the swing arm mechanism and the push rod 210, and the ejector 310 then lifts the supporting part 214 to open the lid 110. When the lid 110 is closed, the supporting part 214 presses the ejector 310 again, and the ejector 310 is restored to close the lid 110. Therefore, the lid 110 can be conveniently opened not only by stepping but also by pressing, leading to increased practicability and convenience.

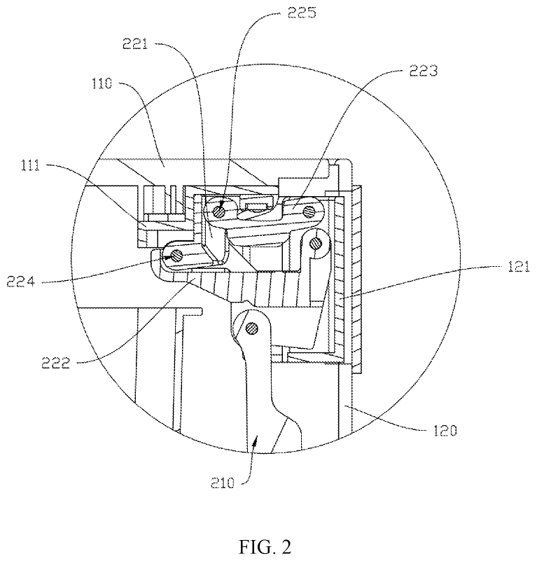

It can be understood that, referring to FIG. 1 and FIG. 2, the swing arm mechanism includes a first swing arm 221, a second swing arm 222, and a third swing arm 223. The second swing arm 222 has a greater length than the third swing arm 223. The first swing arm 221 is provided with a first end 224 and a second end 225. One end of the second swing arm 222 is articulated with the can body 120, and the other end of the second swing arm 222 is articulated with the first end 224. One end of the third swing arm 223 is articulated with the can body 120, and the other end of the third swing arm 223 is articulated with the second end 225. The push rod 210 is articulated with the second swing arm 222. When the lid 110 is opened and rotated by means of the second swing arm 222 and the third swing arm 223, the lid 110 is first raised upwards before being rotated, so as to prevent the lid 110 from interfering with the can body 120 and failing to be opened, and therefore the lid 110 can be opened smoothly. Moreover, when the lid 110 is pressed by means of the first swing arm 221, the lid 110 drives the first swing arm 221 to move. The first swing arm 221 drives the second swing arm 222 and the third swing arm 223 to swing downwards to drive the push rod 210 to move downwards. The push rod 210 triggers the ejector 310, and when the lid 110 is released, the ejector 310 pushes up the push rod 210 to open the lid 110 and keeps the lid 110 open, so that trash can be conveniently thrown into the opening. When the lid 110 needs to be closed, the lid 110 can be manually closed, to cause the push rod to trigger the ejector 310 again, and the ejector 310 is restored to close the lid 110. In addition, when the lid 110 moves towards the opening, the first swing arm 221 rotates around the second end 225, to facilitate rotating of the lid 110 towards the opening, preventing an end of the lid 110 connected to the swing arm mechanism from being tilted when the lid 110 is pressed, and therefore the lid 110 can be smoothly pressed and prevented from being damaged.

It can be understood that referring to FIG. 1 and FIG. 2, the can body 120 is provided with a first connector 121, and the second swing arm 222 and the third swing arm 223 are articulated with the can body 120 through the first connector 121. The can body 120 is connected to the first swing arm 221, the second swing arm 222 and the third swing arm 223 through the first connector 121, thereby facilitating assembly and improving assembly efficiency.

It can be understood that referring to FIG. 1 and FIG. 2, the lid 110 is provided with a second connector 111 connected to the first swing arm 221. A side of the second connector 111 facing the first swing arm 221 is provided with a notch matching the first swing arm 221. Since the second connector 111 is connected to the first swing arm 221, the lid 110 can be quickly connected to the first swing arm 221, increasing the assembly efficiency. Moreover, by arranging the notch, the first swing arm 221 can be accommodated in the notch, such that the swing arm mechanism is compact and the strength of the swing arm mechanism is enhanced.

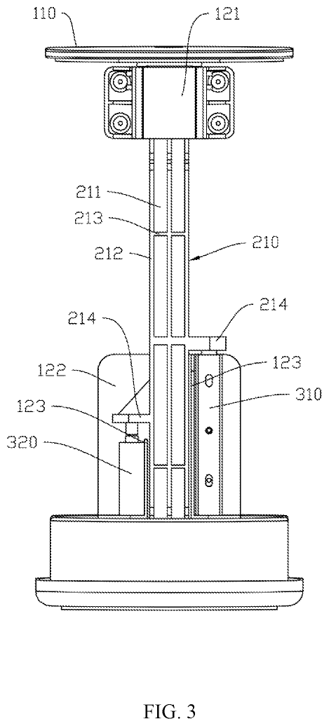

It can be understood that, referring to FIG. 3, the can body 120 is provided with a buffer 320, and the push rod 210 is provided with a first contact plate, which abuts against a movable end of the buffer 320. By arranging the buffer 320, when the trash can is opened by stepping, as the lid 110 is lowered, the buffer 320 acts on the push rod 210 to cause the swing arm mechanism to rotate slowly, achieving a slow lowering of the lid 110, avoiding the lid 110 from closing too fast to create noise and at the same time prolonging the service life of the lid 110.

It can be understood that, referring to FIG. 3, since the buffer 320 and the ejector 310 are located at two sides of the ejector 210, respectively, the space occupied by the can body 120 is saved, making the can body 120 compact, and increasing the structural stability.

It can be understood that, referring to FIG. 3, the push rod 210 includes a first plate 211 and a plurality of second plates 212. The first plate 211 is arranged in a vertical direction, and the plurality of second plates 212 are all arranged at intervals on the first plate 211. A reinforcing rib 213 is arranged between two adjacent second plates 212 to enhance the structural strength between the second plates 212. The first plate 211 is articulated with the swing arm mechanism. By arranging the first plate 211, the push rod 210 is widened, providing a better foot feeling when stepping the can lid 110. By arranging the second plates 212, the rigidity of the first plate 211 is enhanced, further improving the foot feeling when stepping the foot pedal, and the structural strength of the first plate 211 is enhanced, prolonging the service life.

It can be understood that, referring to FIG. 3, the can body 120 is provided with a first partition 122 and at least two second partitions 123. The first partition 122 is arranged in the vertical direction, the at least two second partitions 123 are arranged at intervals on the first partition 122 and are arranged at two sides of the push rod 210, respectively. In this embodiment, two second partitions 123 are arranged through which the buffer 320 and the ejector 310 are connected to the first partition 122, enhancing the stability of the buffer 320 and the ejector 310. Moreover, the strength of the first partition 122 is enhanced through the connection of the two second partitions 123, prolonging the service life of the first partition 122. The two second partitions 123 cooperate to form a guide channel to prevent the push rod 210 from interfering with the ejector 310 and buffer 320 at both sides.

The embodiments of the present disclosure have been described with reference to the accompanying drawing in detail. However, the present disclosure is not limited to the above embodiments, and various changes can be made within the knowledge of those having ordinary skills in the art without departing from the purpose of the present disclosure.

1. A step-on and hand-pressed trash can, comprising:
a main body, comprising a lid and a can body;
a swing arm mechanism, having one end articulated with the lid and the other end articulated with the can body; and
a transmission mechanism, comprising a push rod and an ejector, wherein one end of the push rod is articulated with the swing arm mechanism, and the push rod is provided with a supporting part abutting against a movable end of the ejector.

2. The step-on and hand-pressed trash can of claim 1, wherein the swing arm mechanism comprises a first swing arm, a second swing arm, and a third swing arm, wherein the second swing arm has a greater length than the third swing arm in a horizontal direction; the first swing arm is provided with a first end and a second end; one end of the second swing arm is articulated with the can body and the other end of the second swing arm is articulated with the first end; one end of the third swing arm is articulated with the can body and the other end of the third swing arm is articulated with the second end; and the push rod is articulated with the second swing arm.

3. The step-on and hand-pressed trash can of claim 2, wherein the can body is provided with a first connector, and the second swing arm and the third swing arm are articulated with the can body through the first connector.

4. The step-on and hand-pressed trash can of claim 2, wherein the lid is provided with a second connector connected to the first swing arm, and a side of the second connector facing the first swing arm is provided with a notch matching the first swing arm.

5. The step-on and hand-pressed trash can of claim 1, wherein the can body is provided with a buffer, and the push rod is provided with a first contact plate abutting against a movable end of the buffer.

6. The step-on and hand-pressed trash can of claim 5, wherein the buffer and the ejector are arranged at two sides of the push rod, respectively.

7. The step-on and hand-pressed trash can of claim 1, wherein the push rod comprises a first plate and a plurality of second plates, the first plate is arranged in a vertical direction, the plurality of second plates are all arranged on the first plate at intervals, a reinforcing rib is arranged between two adjacent second plates, and the first plate is articulated with the swing arm mechanism.

8. The step-on and hand-pressed trash can of claim 1, wherein the can body is provided with a first partition and at least two second partitions, the first partition is arranged in the vertical direction, and the at least two second partitions are arranged at intervals on the first partition and are arranged at two sides of the push rod, respectively.
